(19) United States
(12) Patent Application Publication
(10) Pub. No.: US 2003/0114175 A1
(43) Pub. Date: Jun. 19, 2003

(54) Computing device with functional profiles

(76) Inventors: Glenn Andrew Exton, Eltham (AU); Ashley Cook, Yarravillle (AU); Daniel Slusarek, East Brunswick (AU); Emmanuel Karaminas, Glen Waverley (AU); Steven William Pickstone, Glen Iris (AU); Stuart McDonald, Carlton North (AU); Jean Herman Emmanuel, Ferntree Gully (AU)

Correspondence Address: HEWLETT-PACKARD COMPANY, Intellectual Property Administration, P.O. Box 272400, Fort Collins, CO, 80527-2400, US

(21) Appl. No.: 10/273,736

(22) Filed: Oct. 18, 2002

(30) Foreign Application Priority Data
Dec. 10, 2001 (SG) 200107807-0

(51) Int. Cl. H04Q 7/20

(52) U.S. Cl. 455/466

(57) ABSTRACT

A method of enhancing the functionality and usability of a computing device includes the step of defining a plurality of functional profiles, each functional profile having a layout appearance and one or more indicators associated with applications. The functional profiles are then stored, and one of the functional profiles is activated using a functional profile selector or triggered by external communications to a personal digital assistant, e.g. SMS. Thereafter, an application is activated by selecting one of the indicators from those displayed in the layout appearance for the activated functional profile.

### FIELD OF THE INVENTION

This invention relates to enhancing computing device functionality. It relates particularly but not exclusively to a method of enhancing the functionality of a computing device using functional profiles and to a computing device which incorporates functional profiles.

### BACKGROUND OF THE INVENTION

Electronic devices are rapidly becoming integrated into almost every aspect of daily life. Applications have been developed which are configurable to be executed on a plurality of computing devices, which assist users in organisation of tasks, management of time, storage and retrieval of information and many other functions. The number of different applications which are available, and the variety of functions which they provide impart an adjustable management environment which can be configured to suit the requirements of almost any user.

The rapid development of computing technology which has taken place in recent years has resulted in more substantial and faster computer processing power, extensive storage capabilities and applications with an ability to handle graphics and sound in addition to more traditional text-based applications. Furthermore, the development of secure communications networks including local area networks (LANs), intranets and wide area networks (WANs) such as the Internet has significantly influenced the globalisation of world economies and social-environments.

Electronic components which are used to realise this technology have been significantly miniaturised when compared to their valve-based predecessors. Power supplies for mobile computing devices have evolved into smaller packages with longer-lives and more reliable sources of power. The decrease in cost of technology has resulted in electronic devices such as media players, mobile telephones, laptop computers and personal digital assistants (PDAs) becoming everyday tools among many citizens in most developed nations.

As computing hardware has become more powerful, so too have the software packages which are available for execution on computing devices. These software packages include word processing packages, spreadsheet and accounting packages, database programs, scheduling tools, drawing and image processing tools, control systems and abstract mathematics and physics processing packages. It is not unusual for a user of a computing device to use more than one of these types of packages, and that their usage of the packages varies, depending on the user's daily routine and the functions which are required of the device at different times of the day, week, month, year etc.

An object of the present invention is to provide a new way for a user to interact with a computing device in order to access different software applications based on the role the user undertakes at a particular point in time.

### SUMMARY OF THE INVENTION

According to a first aspect of the invention, there is provided a method of enhancing the functionality of a computing device, the method including the following steps:

(a) defining a plurality of functional profiles, each functional profile having:

(i) a layout appearance; and

(ii) one or more indicators associated with applications;

(b) storing the functional profiles;

(c) activating one of the functional profiles using either:

(i) a functional profile selector; or

(ii) external triggering communications; and

(d) activating an application by selecting one of the indicators from those displayed in the layout appearance for the activated functional profile.

A functional profile may be defined in accordance with the requirements of a user of the computing device and may be determined by the “role” which the user is playing at any given instance in time. A user of the computing device may play several roles during any given day, week, month or year, and may require different functionality of the computing device accordingly. The roles may include corporate executive, doctor, technician, consultant, site assessor, nurse, parent, student, courier, teenager or traveller to name a few.

As a person changes his or her role say, from executive sales to casual financial investor, the functional requirements of their computing device also change. The executive sales role may require access to applications such as database programs with customer data and supplier data, GPS maps, contact lists and secure email. The casual financial investor role may require access to applications such as secure email, a company scoreboard, stock watch and trading agencies over the Internet.

The layout appearance refers to the appearance of the indicators on the display unit of the computing device. The layout appearance may be standard across all functional profiles which are defined for a computing device. Alternatively, the layout appearance may be different for different functional profiles, to accommodate the requirements of the role for which the functional profile has been defined and the mobile computing device form factor, resolution, colour support etc.

It is preferred that applications which are associated with indicators for a functional profile can be configured in accordance with the requirements of a user of the computing device. It is possible that one application is required by more than one role, and that the requirements of that application differ depending on the role. Accordingly, it is preferred that the applications which are associated with indicators of a functional profile are configurable to suit the functional profile with which they are associated. To demonstrate by way of example, for an executive sales-type functional profile, a database application may be configured to open with customer data and supplier data immediately available, while a database which is associated with a casual investor-type functional profile may be configured to open with a history of the user's trades immediately available.

Each functional profile has one or more indicators. It is preferred that there is one indicator for each application which is associated with a functional profile. Suitable types of indicators include buttons, icons, or items in a menu which can be identified and selected by a user of the computing device. Alternatively, the indicators may be any other indicating mark which the user can select to execute an associated application.

The functional profile selector may be an indicator such as an icon which is present on a display associated with the computing device and which can be seen and selected by a user of the computing device. It is preferred that the functional profile selector is an icon on a screen of the computing device which, when selected by the user, presents the user with a list of the functional profiles which have been defined and stored on the computing device. It is preferred that the user can then scroll down the list and select the functional profile which best suits the role which the user is playing, thereby activating that functional profile.

Alternatively, when the user selects the functional profile selector, say using the stylus of a personal digital assistant, the functional profile may switch to the next available functional profile which is stored on the computing device. A subsequent selection of the functional profile selector with a stylus or other selection device will result in switching to still the next functional profile, and so on. In the latter embodiment, the user may be presented with an option to return to the main operating default state of the mobile computing device through which the user may adjust settings which relate to enhancing the functionality of the computing device by adjusting, adding to or deleting from the existing functional profiles, or changing other features of the computing device. Alternatively, holding a selection tool such as the stylus of a personal digital assistant on the functional profile selector for a certain length of time may provide access to the underlying operating system of the computing device. This may occur after the user has been presented with a list of available functional profiles.

Alternatively, the functional role based profile may be activated through external communications to the personal digital assistant initiated by SMS (Short Message Service) triggering conditions.

According to a second aspect of the present invention, there is provided a computing device with enhanced functionality, the computing device including:

(a) a profile definition software component for defining and storing a plurality of functional profiles wherein each functional profile has:

(i) a layout appearance; and

(ii) one or more indicators associated with applications;

(b) a profile managing software component for activating a profile; and

(c) presentation apparatus for displaying the layout appearance to a user of the device.

The computing device may be any computing device with functionality which may be enhanced. The computing device may be one of the following:

(a) a personal digital assistant; or

(b) a mobile telephone; or

(c) a laptop computer; or

(d) any other mobile computing device.

The profile definition software component may be any program which enables a user of the computing device to define functional profiles which are useful when the user is playing a particular role. The profile definition software component may be in the form of a database, wherein functional profiles are defined along with the indicators and associated applications which are required for that functional profile. Such a database may also include configuration files for a layout appearance associated with the functional profile.

It is preferred that an application associated with an indicator is configurable for use in one or more functional profiles. In such an embodiment, the profile definition software component may also be used to store configuration files which are used to configure applications which are associated with particular functional profiles. Such an embodiment enables applications which are available in more than one functional profile to be configured differently, in accordance with the requirements of the role for which the functional profile has been defined.

It is also preferred that the functional profile includes one or more of the following characteristics:

(a) a colour scheme;

(b) a layout of the one or more indicators;

(c) shape of the one or more indicators;

(d) means of selecting the one or more indicators; and

(e) sounds which are produced by the device.

The layout appearance of the functional profile may be uniform across the plurality of functional profiles which are defined. However, it is preferred that the layout appearance of functional profiles can be determined by the user of the computing device. In such a preferred embodiment, the user may prefer to create a layout which is formal for a vocational role and more colourful and informal for a non-vocational role such as “sports fan”.

The one or more indicators associated with applications may be any indicators which can be selected by a user of the computing device and which executes an application or open a file. The indicator may be in the form of an icon or a menu bar with different items that refer to applications associated with a functional profile presented to the end user based on the form factor, resolution, colour of the mobile computing device.

The profile managing software component may be any component which activates a profile. The profile managing software component may be accessed by selecting icon or other indicator on a display of the computing device which can be selected using say, a mouse or stylus of a personal digital assistant. Alternatively, the profile managing software component may be accessed by selecting a button or switch which is located on the casing of the computing device. When the profile managing software component is selected, it is preferred that the user is presented with a list of the functional profiles which have been defined on the computing device, and that the user can then select the functional profile which is best suited to the role that they are about to play. Alternatively, the user may be presented with an option to return to the main operating default state of the mobile computing device through which the user may adjust settings which relate to enhancing the functionality of the computing device by adjusting, adding to or deleting from the existing functional profiles, or changing other features of the computing device.

Alternatively, the functional role based profile may be activated through external communications to the personal digital assistant initiated by SMS triggering conditions.

In yet another alternative, the user may hold a selection device, such as a mouse or stylus on an icon which provides access to the profile management software component, and after a set period of time, the user may be presented with a view of the underlying operating system.

The presentation apparatus may be any apparatus which is used to deliver the enhanced functionality of the computing device to its user. The presentation apparatus may be the screen of a laptop computer, personal digital assistant or mobile telephone or any other display which can be used with a computing device.

### BRIEF DESCRIPTION OF THE DRAWINGS

The invention will herein after be described in greater detail by reference to the attached drawings. It is to be Understood that the particularity of the drawings does not supersede the generality of the preceding description of the invention.

FIG. 1 is a flow diagram which illustrates an embodiment of the present invention.

FIG. 2 is a figure of architecture which illustrates interaction of aspects of an exemplary embodiment of the present invention.

FIG. 3 is an example of a layout appearance of an embodiment of the present invention.

### DETAILED DESCRIPTION

The present method enables users of computing devices such as personal digital assistants (PDAs) to maximize and focus the functionality of their computing environment. This is especially valuable for mobile computing environments where battery life and processing time may be limited. It facilitates the loading and launching of dedicated application suites which are tailored to deliver a core functionality. As a user negotiates his or her way through a series of role changes, the appearance and behaviour of the computing device also changes to support tasks which are performed in the execution of that role. This results in an improvement in usability and efficiency for the end user. Such role transitions may include the following:

(a) Driver to Field Service Engineer;

(b) Field Service Engineer to Salesman;

(c) Salesman to Parent;

(d) Parent to Gardener; and

(e) Gardener to Sports Fan.

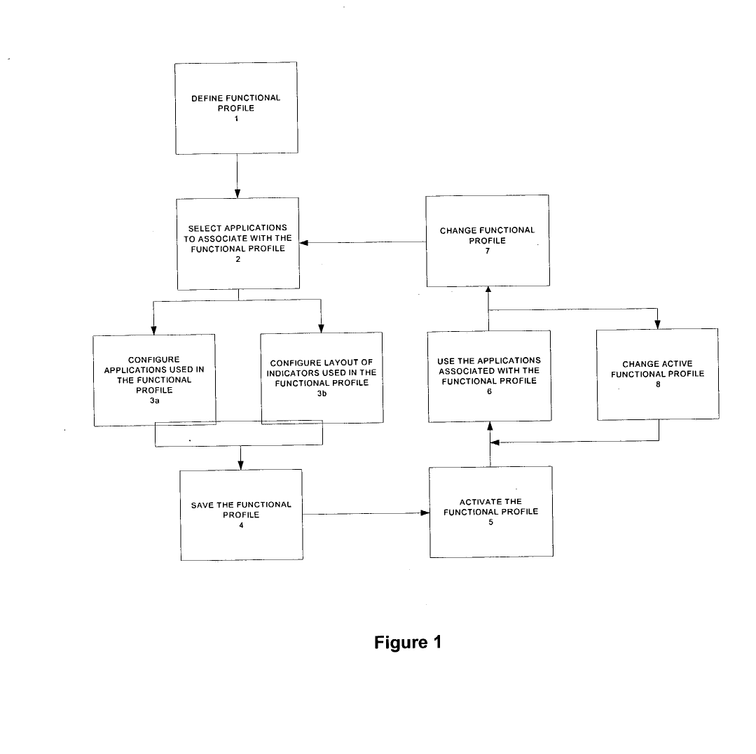

Referring firstly to FIG. 1, there is shown a block diagram of an embodiment of the invention. In Block 1, a user of a computing device such as a PDA defines a functional profile using software which has been installed on the PDA or which is made resident on the device during manufacture.

In Block 2, the user selects applications which are to be associated with a functional profile in support of a role for which the functional profile will be activated. In Block 3a, the application is configured in accordance with the requirements of the role. In Block 3b, the layout and/or appearance of icons or other indicators which are used to show which applications are available in a functional profile are configured. This may involve positioning the icons on the screen and recolouring aspects of presentation or it may involve more complex features of appearance and layout. One example of a layout which may be used to present a functional profile is illustrated in FIG. 3.

In FIG. 3, a screen of a PDA is shown with a presentation layout where the role for which the functional profile was defined as “stocks trader”. In FIG. 3 the applications available through the functional profile are:

(a) secure email;

(b) Internet browser;

(c) financial calculator;

(d) online trader;

(e) media player; and

(f) synchronisation module.

These applications are frequently used when the PDA user is performing in this role. FIG. 3 also illustrates the way in which the interface or presentation layer can be customised to deliver the necessary functionality and be visually appealing to the user.

The functional profile is then saved as indicated in Box 4 of FIG. 1 and activated as in Box 5. Activation of a functional profile may occur by selecting an icon on the screen of the computing device. In FIG. 3, icon 31 is used to select the active functional profile. When a PDA stylus contacts icon 31, a menu listing the stored functional profiles is displayed, from which a different functional profile can be selected as may be required when the user assumes a different role. When a particular functional profile has been activated, the user is able to access the applications to perform the requisite tasks as in Box 6. The active functional profile may be changed in a manner similar to that in which the previous profile was activated, using an icon such as icon 31 in FIG. 3. The user may also wish to change a functional profile, add a new functional profile or delete an existing functional profile as in Box 7 or change to a new active functional profile as in Box 8.

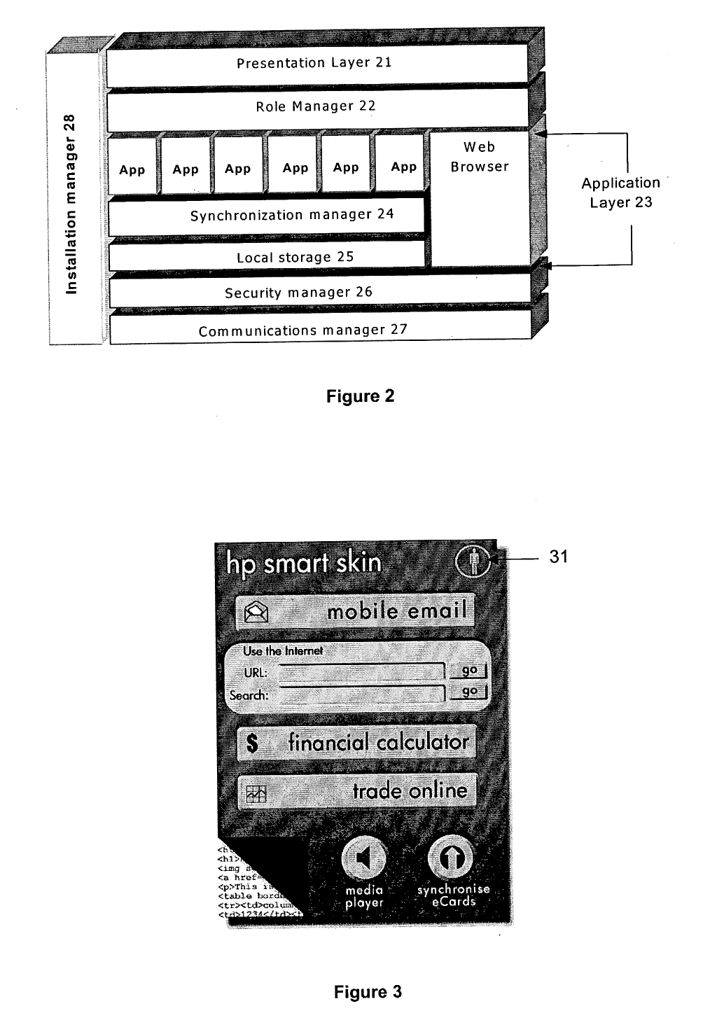

FIG. 2 illustrates the interaction of layers of system architecture which can be used to exemplify the present invention. Presentation layer 21 delivers the functional profile to the user. It acts as an interface between the user and the operating system and multiplicity of underlying applications and data-stores which are available on the computing device. Role Manager 22 is accessed by the user through presentation layer 21. It provides a list of functional profiles which are available on the computing device and which can be selected by the user. Once a new functional profile is selected by the user, Role Manager 22 replaces the existing presentation layer with a different presentation layer which has been configured for the newly selected functional profile. Applications which were defined for the newly selected functional profile are then brought into view, replacing the applications which were in view when the previous functional profile was active. Application layer 23 is responsible for the provision of applications which are available through presentation layer 21. Application layer 23 may also store configuration entries which identify:

(a) applications which are currently installed on the computing device and configured for use with more than one functional profile;

(b) applications which are currently installed on the computing device and were previously configured for use with more than one functional profile;

(c) applications which have been installed previously and were configured for use with one or more mobile role based interface; and

(d) applications which are remote to the mobile computing device but accessed via pre-programmed links.

Synchronisation Manager 24 coordinates and facilitates synchronisation of data between local and remote data stores for installed and configured applications. Local Storage 25 is a requirement of most computing devices and can be configured to store a variety of data types including XML documents, flat files, compressed files and relational databases.

Security layer 26 facilitates encryption of stored and transmitted data, which is necessary for the integrity and security of mobile computing devices that transfer data over public communications networks. As illustrated in FIG. 2, all applications have access to security layer 26. Further, security layer 26 may be accessed by the user through the computing device's operating system to facilitate adjustment of preference settings.

Communications manager 27 coordinates incoming and outgoing data packets between external devices which are connected via a communications network and the local applications which are running on the mobile computing device.

Installation manager 28 facilitates installation and removal of functional profiles from the computing device. Installation manager 28 also expands and deploys components of functional profiles into appropriate directories and makes configuration entries into configuration files which are stored by the computing device.

It is to be understood that various alterations, additions and/or modifications may be made to the parts previously described without departing from the ambit of the present invention.

1. A method of enhancing the functionality of a computing device, the method including the following steps:
(a) defining a plurality of functional profiles, each functional profile having:
(i) a layout appearance; and
(ii) one or more indicators associated with applications;
(b) storing the functional profiles;
(c) activating one of the functional profiles using either:
(i) a functional profile selector; or
(ii) external triggering communications; and
(d) activating an application by selecting one of the indicators from those displayed in the layout appearance for the activated functional profile.

2. A method of enhancing the functionality of a computing device according to claim 1, the method including the additional step of configuring one or more of the applications which are associated with indicators for a functional profile.

3. A method of enhancing the functionality of a computing device according to claim 2 wherein an application which is associated with more than one indicator may be configured differently for each indicator with which the application is associated.

4. A method of enhancing the functionality of a computing device according to claim 1 wherein one of the functional profiles is activated using external triggering communications and the external triggering communications use a short message service (SMS) communication to activate the functional profile.

5. A computing device with enhanced functionality, the computing device including:
(a) a profile definition software component for defining and storing a plurality of functional profiles wherein each functional profile has:
(i) a layout appearance; and
(ii) one or more indicators associated with applications;
(b) a profile managing software component for activating a profile; and
(c) presentation apparatus for displaying the layout appearance to a user of the device.

6. A computing device with enhanced functionality according to claim 5 wherein a functional profile includes one or more of the following characteristics:
(a) a colour scheme;
(b) a layout of the one or more indicators;
(c) shape of the one or more indicators;
(d) means of selecting the one or more indicators; and
(e) sounds which are produced by the device.

7. A computing device according to claim 5 wherein an application associated with an indicator is configurable for use as part of one or more functional profiles.

8. A computing device according to claim 5 wherein the device is one of the following:
(a) a personal digital assistant; or
(b) a mobile telephone; or
(c) a laptop computer; or
(d) any other mobile computing device.
